(19) United States
(12) Patent Application Publication
(10) Pub. No.: US 2017/0289723 A1
(43) Pub. Date: Oct. 5, 2017

(54) AUDIO OUTPUT CONTROLLING METHOD BASED ON ORIENTATION OF AUDIO OUTPUT APPARATUS AND AUDIO OUTPUT APPARATUS FOR CONTROLLING AUDIO OUTPUT BASED ON ORIENTATION THEREOF

(71) Applicant: RADSONE INC., Seongnam-si (KR)

(72) Inventors: Chul Jae YOO, Seongnam-si (KR); Woo Suk LEE, Seoul (KR)

(73) Assignee: RADSONE INC., Seongnam-si (KR)

(21) Appl. No.: 15/479,683

(22) Filed: Apr. 5, 2017

(30) Foreign Application Priority Data
Apr. 5, 2016 (KR) 10-2016-0041509

(51) Int. Cl. H04S 7/00; H04S 3/00

(52) U.S. Cl. CPC H04S 7/30; H04S 3/002; H04S 2400/03

(57) ABSTRACT

Provided is a method of controlling an audio output according to an orientation of an audio output apparatus, performed by the audio output apparatus, the method including receiving a stereo signal; detecting the orientation of the audio output apparatus using a sensor; outputting the stereo signal to a left speaker unit and a right speaker unit from a viewpoint of a user who views a front surface portion of the audio output apparatus on which two speaker units are arranged; and down-mixing the stereo signal and outputting the down mixed signal to at least one among an upper speaker unit and a lower speaker unit from the user's viewpoint.

### CROSS-REFERENCE TO RELATED APPLICATION

This application claims the benefit under 35 USC 119(a) of Korean Patent Application No. 10-2016-0041509 filed on Apr. 5, 2016 in the Korean Intellectual Property Office, the entire disclosure of which is incorporated herein by reference for all purposes.

### BACKGROUND

### 1. Field of the Disclosure

The following description relates to an audio output apparatus.

### 2. Discussion of Related Art

Recently, with the advent of mobile devices such as smart phones, the market of wireless speakers such as Bluetooth speakers has grown. In general, Bluetooth speakers have portability.

### SUMMARY OF THE INVENTION

In one general aspect, there is provided a method of controlling an audio output according to an orientation of an audio output apparatus, performed by the audio output apparatus, includes receiving a stereo signal, detecting the orientation of the audio output apparatus using a sensor, outputting the stereo signal to a left speaker unit and a right speaker unit from a viewpoint of a user who views a front surface portion of the audio output apparatus on which two speaker units are arranged, and down-mixing the stereo signal and outputting the down mixed signal to at least one of an upper speaker unit and a lower speaker unit from the user's viewpoint.

In another general aspect, there is provided an audio output apparatus for controlling an audio output according to an orientation thereof includes a sensor configured to sense the orientation of the audio output apparatus; a digital-to-analog converter (DAC) configured to convert a digital signal processed by a processor into an analog signal; speaker units including two speaker units arranged on a first side surface of a housing of the audio output apparatus, one speaker unit arranged on a second side surface extending from the first side surface in one direction, and one speaker unit arranged on a third side surface extending from the first side surface in a direction opposite to the one direction; and the processor configured to control a stereo signal to be output to speaker units located at left and right sides from a viewpoint of a user who views the first side surface according to the orientation, and control a signal obtained by down-mixing the stereo signal to be output to at least one of an upper speaker unit and a lower speaker unit from the user's viewpoint.

### BRIEF DESCRIPTION OF THE DRAWINGS

FIG. 1 illustrates an example of a diagram for an audio output apparatus.

FIG. 2 illustrates an example of a block diagram for an audio output apparatus.

FIG. 3 illustrates an example of a horizontal mode of an audio output apparatus.

FIG. 4 illustrates another example of a horizontal mode of an audio output apparatus.

FIG. 5 illustrates yet another example of a horizontal mode of an audio output apparatus.

FIG. 6 illustrates an example of a vertical mode of an audio output apparatus.

FIG. 7 illustrates another example of a vertical mode of an audio output apparatus.

FIG. 8 illustrates an example of a flowchart for a method of controlling sound to be output from speaker units.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION OF EXEMPLARY EMBODIMENTS

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

As used herein, the term “and/or” includes any one and any combination of any two or more of the associated listed items.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The following examples relates to an audio output apparatus (e.g., a speaker). The audio output apparatus may have various external shapes, e.g., a hexahedral shape, another polyhedral shape, a cylindrical shape, a spherical shape, or the like. The audio output apparatus to be described hereinafter may be arranged in various directions. Furthermore, the audio output apparatus to be described hereinafter includes a plurality of speaker units having different orientations.

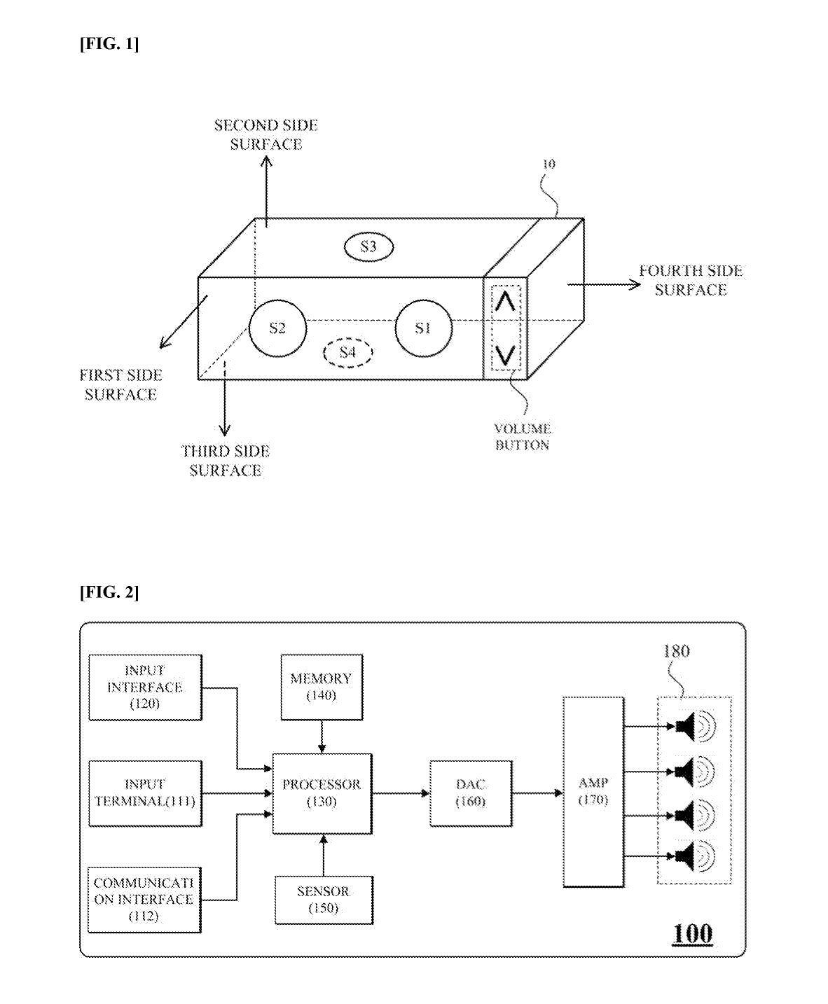

For convenience of explanation, an audio output apparatus having a hexahedral shape will be described below. FIG. 1 illustrates an example of a diagram for an audio output apparatus 10. The audio output apparatus 10 includes a housing having a hexahedral shape (or a square pillar shape). In FIG. 1, the audio output apparatus 10 includes a button for adjusting the volume of sound. Alternatively, various shape of input devices, interface devices, and such other than those shown in FIG. 1 may be used.

The audio output apparatus 10 includes four speaker units S1, S2, S3, and S4 exposed to the outside of the housing. At least some of these speaker units have different directionalities. FIG. 1 illustrates four side surfaces (a first side surface, a second side surface, a third side surface, and a fourth side surface) of the housing to explain surfaces of the housing on which these speaker units are arranged. The two speaker units S1 and S2 are arranged on the first side surface. The speaker unit S3 is arranged on the second side surface extending from the first side surface. The speaker unit S4 is arranged on the third side surface extending from the first side surface. Alternatively, a plurality of speaker units may be arranged on the second or third side surface. The fourth side surface is illustrated to explain a direction in which the audio output apparatus 10 faces. Basically, a user may listen to music while facing the first side surface. In this case, the first side surface may be a direction toward the user. Thus, the first side surface may be referred to as a front surface portion.

As described above, the audio output apparatus 10 may have various external shapes. Referring to FIG. 1, the audio output apparatus 10 has a pillar shape with cross sections having a square shape. Alternatively, the audio output apparatus 10 may have cross sections having a polyhedral shape other than the square shape or having a round shape. In this case as well, the audio output apparatus 10 may have different directions in which a plurality of speaker units S1, S2, S3 and S4 face outward.

As will be described below, each of the speaker units outputs various types of signals in accordance with the arranged orientation of the audio output apparatus 10. Therefore, it is preferable to use a speaker unit capable of outputting from low-frequency to high-frequency sound range of each speaker unit.

The audio output apparatus 10 detects the orientation thereof and performs control to output sound appropriate for a user according to the orientation. The audio output apparatus 10 may control different signals to be output to the speaker units S1, S2, S3, and S4 according to the orientation, as will be described in detail below.

FIG. 2 illustrates an example of a block diagram for an audio output apparatus 100. FIG. 2 illustrates the audio output apparatus 100 as an example to explain the structure of the audio output apparatus 10 of FIG. 1. Referring to FIG. 2, the audio output apparatus 100 includes an input terminal 111, a communication interface 112, an input interface 120, a processor 130, a memory 140, a sensor 150, a digital-to-analog converter (DAC) 160, an amplifier (AMP) 170, and speaker units 180.

The input terminal 111 is configured to receive a digital audio signal via wire. The communication interface 112 is configured to wirelessly receive a digital audio signal. The communication interface 112 may be a device based on Bluetooth, Wi-Fi, or a short-range communication protocol. An audio signal input to the input terminal 111 or the communication interface 112 may have a format such as the integrated inter-chip sound (I²S) format or the Sony/Philips digital interface format (S/PDIF). The FS format is a digital audio signal transmission standard. The S/PDIF is a digital audio signal transmission standard suggested by Sony/Philips. Basically, an audio signal is a digital stereo signal.

The input interface 120 is a device which transmits a control command to the audio output apparatus 100. For example, the input interface 120 may be a volume control device, an equalizer, a power switch, or the like. A user may also transmit a control command to the audio output apparatus 100 via the communication interface 112.

The sensor 150 is a device which senses the orientation of the audio output apparatus 100. The sensor 150 may include at least one among an acceleration sensor, a gyro sensor, and a geomagnetic sensor. The sensor 150 detects the orientation of the audio output apparatus 100 in a three-dimensional (3D) space.

The processor 130 processes an input digital audio signal received in accordance with the orientation of the audio output apparatus 100 in a constant manner. The processor 130 is a digital signal processor (DSP) or a central processing unit (CPU). (i) The processor 130 may down-mix a stereo signal (including a left-channel signal and a right-channel signal). (ii) The processor 130 may divide a signal obtained by down-mixing the stereo signal according to a certain frequency band. For example, the processor 130 may perform crossover to divide the signal obtained by down-mixing the stereo signal into a low-frequency signal and a high-frequency signal. Crossover is performed to output a signal of a different frequency band for each of the speaker units 180. The processor 130 may filter the left-channel signal and/or the right-channel signal into a high-frequency signal by using a high pass filter (HPF). The processor 130 may filter the left-channel signal and/or the right-channel signal into a low-frequency signal by using a low-pass filter (LPF). (iii) The processor 130 may put the low-frequency signal to be in constant overdrive. Overdrive means amplifying a signal to a certain level. (iv) The processor 130 may perform sound volume control. (v) The processor 130 may determine a speaker unit through which a processed signal is to be output. (vi) The processor 130 may control the phase and intensity of a signal. Furthermore, the processor 130 may control signals output from the respective speaker units 180 to have different phases and intensities.

The processor 130 processes an audio signal to provide a user with higher quality of sound according to the orientation of the audio output apparatus 100, and determines signals to be output from the speaker units 180. The processor 130 combines various audio signal processings described above and transmits processed signals to the speaker units 180 according to the orientation of the audio output apparatus 100. Thus, the processor 130 may give effects such as stereo widening and center enhancement. An example in which the processor 130 processes an audio signal according to the orientation of the audio output apparatus 100 will be described in detail below.

The memory 140 may store an instruction to be used by the processor 130 to process a signal. Alternatively, the processor 130 may process a signal without using the memory 140.

The DAC 160 is a digital-to-analog converter which converts a signal processed by the processor 130 into an analog signal. The AMP 170 is an amplifier which amplifies the analog signal output from the DAC 160.

FIG. 2 illustrates the speaker units 180. The speaker units 180 are devices which finally output sound.

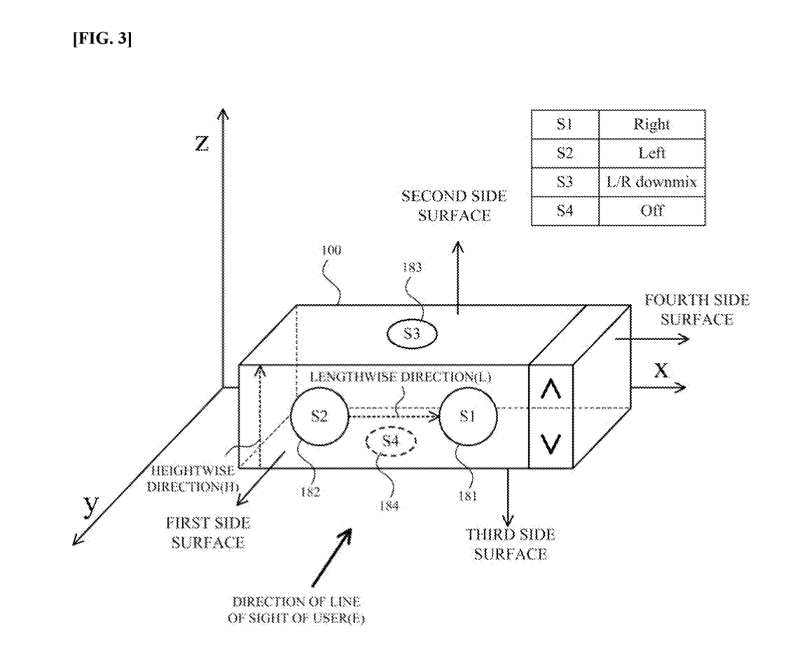

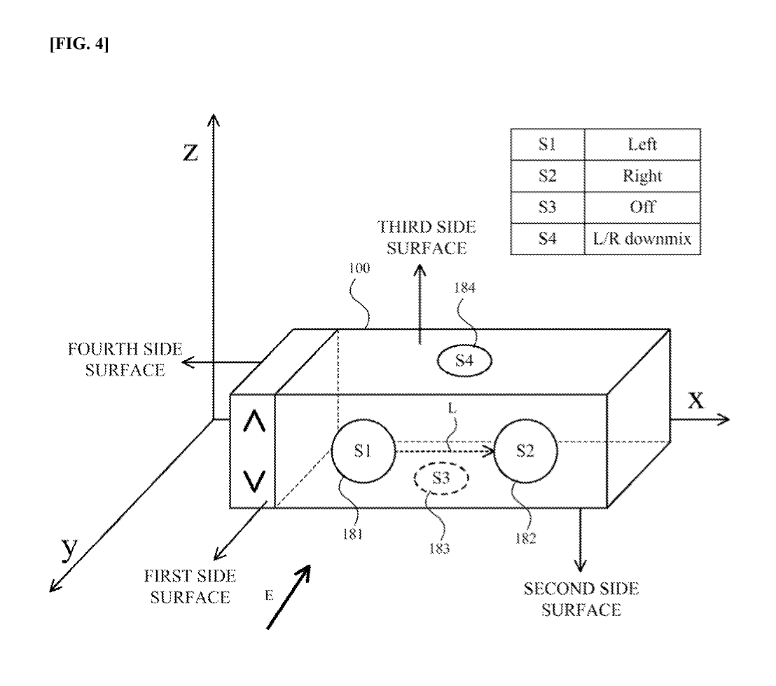

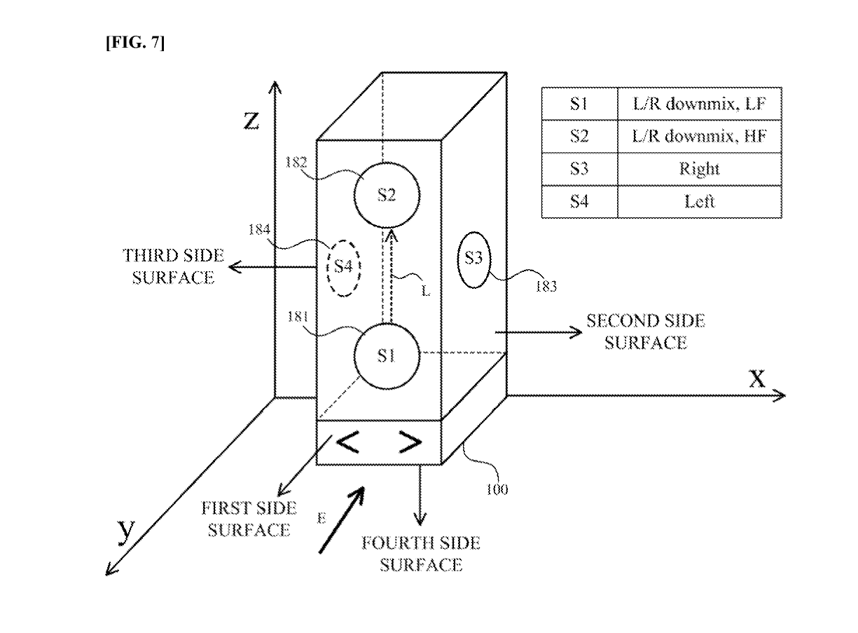

An example in which an audio signal is processed according to the orientation of the audio output apparatus 100, and a speaker unit which outputs the processed signal will be described below. The orientation of the audio output apparatus 100 is largely divided into two modes. The two modes include a horizontal mode and a vertical mode. FIGS. 3 to 7 illustrate examples of an orientation of an audio output apparatus in a 3D space. FIGS. 3 to 5 illustrate examples of the horizontal mode. FIGS. 6 and 7 illustrate examples of the vertical mode. FIGS. 3 to 7 illustrate an audio output apparatus 100 having the same structure as that of the audio output apparatus 10 of FIG. 1.

First, parts of FIG. 3 which are common in FIGS. 3 to 7 will be described. It is assumed that the audio output apparatus 100 is arranged in a 3D space with an x-axis, a y-axis, and a z-axis. In this case, it is assumed that a user is located in a direction toward a ZX plane. In FIG. 3, a direction of a line of sight of the user is indicated by an arrow E.

The orientation of the audio output apparatus 100 may be described according to various reference points. In FIG. 3, a virtual straight line connecting two speaker units S1 181 and S2 182 arranged on a first side surface of the audio output apparatus 100 to each other is illustrated. Here, it is defined that a direction of the straight line connecting the speaker units S1 181 and S2 182 to each other is a lengthwise direction L. A case in which the lengthwise direction L is horizontal to an XY plane will be defined as the horizontal mode. A case in which the lengthwise direction L forms an acute angle with respect to the XY plane may be determined as the horizontal mode. For example, a case in which an angle formed by the lengthwise direction L and the XY plane is an acute angle of 10 degrees or less may be determined as the horizontal mode. The lengthwise direction L and the XY plane may not be exactly horizontal to each other when a floor surface on which the audio output apparatus 100 is put is not even, when a surface of the audio output apparatus 100 which is in contact with the floor surface is not even, or when the speaker units S1 181 and S2 182 are not put on the same plane on the first side surface in a heightwise direction H of the audio output apparatus 100. The XY plane may be a virtual horizontal plane or the floor surface on which the audio output apparatus 100 is put.

A case in which the lengthwise direction L is perpendicular to the XY plane is defined as the vertical mode. Furthermore, a case in which the lengthwise direction L forms an acute angle with respect to the XY plane may be also defined as the vertical mode.

FIG. 3 illustrates an example of a horizontal mode of an audio output apparatus 100. In FIG. 3, it is assumed that the lengthwise direction L and the XY plane are horizontal to each other. The lengthwise direction L and the XY plane may be horizontal to each other in two directions. FIG. 3 illustrates one of horizontal modes. FIG. 3 illustrates a case in which a direction of a fourth side surface of the audio output apparatus 100 and a direction of an X-axis are the same. The horizontal mode illustrated in FIG. 3 will be defined as a first horizontal mode.

Signals to be respectively output to the speaker units S1 181 and S2 182 in the first horizontal mode will be described below. Basically, the speaker unit S1 181 and the speaker unit S2 182 arranged on the first side surface output a stereo signal. The speaker unit S2 182 located at the left of a line of sight of a user outputs a left-channel signal Left. The speaker unit S1 181 located at the right of the line of sight of the user outputs a right-channel signal Right. A speaker unit S3 183 arranged on a second side surface of the audio output apparatus 100 outputs a signal L/R downmix obtained by down-mixing the stereo signal (including left and right channel signals). A speaker unit S4 184 arranged on a third side surface of the audio output apparatus 100 does not output a signal. The speaker unit S4 184 is in contact with the floor surface and thus does not output sound. However, in some cases, the speaker unit S4 184 may output the signal obtained by down-mixing the stereo signal while it is in contact with the floor surface.

FIG. 4 illustrates another example of a horizontal mode of an audio output apparatus 100. FIG. 4 illustrates one of horizontal modes. FIG. 4 illustrates a case in which a fourth side surface of the audio output apparatus 100 is opposite to an X-axis. The horizontal mode illustrated in FIG. 4 will be defined as a second horizontal mode. Basically, a speaker unit S1 181 and a speaker unit S2 182 arranged on a first side surface of the audio output apparatus 100 output a stereo signal. However, the speaker unit S1 181 located at the left of a line of sight of a user outputs a left-channel signal Left and the speaker unit S2 182 located at the right of the line of sight of the user outputs a right-channel signal Right, unlike in FIG. 3.

A speaker unit S4 184 arranged on a third side surface of the audio output apparatus 100 outputs a signal L/R downmix obtained by down-mixing the stereo signal (including left and right channel signals). A speaker unit S3 183 arranged on a second side surface of the audio output apparatus 100 does not output a signal. The speaker unit S3 183 is in contact with a floor surface and thus does not output sound. However, in some cases, the speaker unit S3 183 may output the signal obtained by down-mixing the stereo signal while it is in contact with the floor surface.

Referring to FIGS. 3 and 4, a signal output from a speaker unit varies according to a position relative to the orientation of the speaker unit. In FIGS. 3 and 4, basically, a speaker unit located on a front surface (e.g., the first side surface) of the audio output apparatus 100 from a user's viewpoint outputs a stereo signal and at least one of speaker units located on the top and bottom of the audio output apparatus 100 outputs a signal obtained by down-mixing the stereo signal. A speaker unit located at the left of the front surface from the user's viewpoint will be referred to as a left speaker unit. A speaker unit located at the right of the front surface from the user's viewpoint will be referred to as a right speaker unit. A speaker unit located on an upper side surface of the audio output apparatus 100 from the user's viewpoint will be referred to as an upper speaker unit. A speaker unit located on a lower side surface of the audio output apparatus 100 from the user's viewpoint will be referred to as a lower speaker unit.

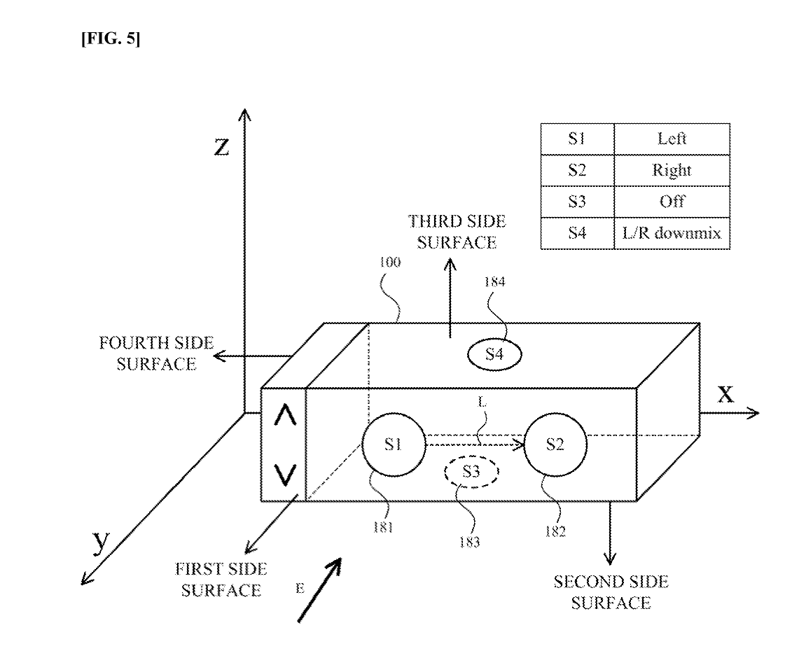

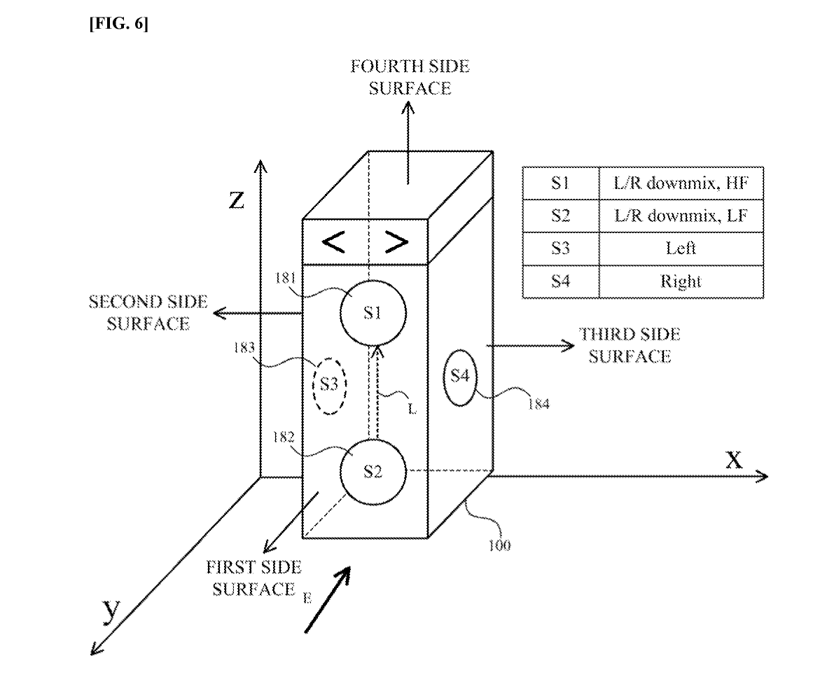

FIG. 5 illustrates yet another example of a horizontal mode of an audio output apparatus 100. In FIG. 5, the audio output apparatus 100 is the same orientation as the audio output apparatus 100 of FIG. 3. However, a third side surface of the audio output apparatus 100 of FIG. 5 and an XY plane form an angle θ together. FIG. 5 illustrates an example in which the third side surface of the audio output apparatus 100 is located on supports each having a certain shape and thus forms an angle with the XY plane. Basically, speaker units S1 181 and S2 182 arranged on a first side surface of the audio output apparatus 100 output a stereo signal. The speaker unit S2 182 located at the left of a line of sight of a user outputs a left-channel signal Left. The speaker unit S1 181 located at the right of the line of sight of the user outputs a right-channel signal Right. A speaker unit S3 183 arranged on a second side surface of the audio output apparatus 100 outputs a signal L/R downmix obtained by down-mixing the stereo signal (including left and right channel signals). A speaker unit S4 184 arranged on the third side surface outputs the signal L/R downmix obtained by down-mixing the stereo signal. The signal output from the speaker unit S4 184 is reflected from a floor surface and is then transmitted to the user. Thus, the signal output from the speaker unit S4 184 may vary according to an angle θ formed between the speaker unit S4 184 and the XY plane. The processor 130 may differently process the signal output from the speaker unit S4 184 according to the angle θ. As described above, the processor 130 may process a signal output from each of these speaker units according to the angle θ to ensure that an effect such as center enhancement occurs around the user.

Although not shown, the XY plane and the second side surface may form an angle together even according to the orientation of the audio output apparatus 100 of FIG. 4 (in which the fourth side surface is opposite to the x-axis). In this case, the speaker unit S3 183 arranged on the second side surface outputs the signal L/R downmix obtained by down-mixing the stereo signal (including the left and right channel signals). The processor 130 may differently process the signal output from the speaker unit S3 183 according to the angle θ.

FIG. 6 illustrates an example of a vertical mode of an audio output apparatus 100. In FIG. 6, it is assumed that a lengthwise direction L is perpendicular to an XY plane. There are two examples of the vertical mode. FIG. 6 illustrates a vertical mode in which a fourth side surface of the audio output apparatus 100 faces a z-axis among vertical modes. The vertical mode of FIG. 6 will be referred to as a first vertical mode.

A signal output from each speaker unit in the first vertical mode will be described below. Basically, speaker units S1 181 and S2 182 arranged on a first side surface of the audio output apparatus 100 output a signal L/R downmix obtained by down-mixing a stereo signal. The speaker unit S1 181 arranged on the first side surface and above a line of sight of a user outputs a high-frequency signal HF. The speaker unit S2 182 arranged on the first side surface and below the line of sight of the user outputs a low-frequency signal LF. A speaker unit S4 184 arranged on a third side surface of the audio output apparatus 100 located at the right of the line of sight of the user who views the first side surface outputs a right-channel signal Right. A speaker unit S3 183 arranged on a second side surface of the audio output apparatus 100 located at the left of the line of sight of the user outputs a left-channel signal Left.

FIG. 7 illustrates another example of a vertical mode of an audio output apparatus 100. FIG. 7 illustrates a vertical mode in which a fourth side surface of the audio output apparatus 100 is opposite to a z-axis among vertical modes. The vertical mode of FIG. 7 will be referred to as a second vertical mode.

A signal output from each speaker unit in the second vertical mode will be described below. Basically, speaker units S1 181 and S2 182 arranged on a first side surface of the audio output apparatus 100 outputs a signal L/R downmix obtained by down-mixing a stereo signal. The speaker unit S2 182 arranged on the first side surface and above a line of sight of a user outputs a high-frequency signal HF. The speaker unit S1 181 arranged on the first side surface and below the line of sight of the user outputs a low-frequency signal LF. A speaker unit S3 183 arranged on a second side surface of the audio output apparatus 100 located at the right of the line of sight of the user who views the first side surface outputs a right-channel signal Right. A speaker unit S4 184 arranged on a third side surface of the audio output apparatus 100 located at the left of the line of sight of the user outputs a left-channel signal Left.

Referring to FIGS. 6 and 7, a signal output from a speaker unit varies according to a position relative to the orientation of the speaker unit. In FIGS. 6 and 7, basically, a speaker unit arranged on a front surface (e.g., the first side surface) of the audio output apparatus 100 from a user's viewpoint outputs a down-mixed signal. Speaker units arranged on right and left side surfaces extending from the front surface from the user's viewpoint output the stereo signal. The speaker unit located on the left side surface of the front surface from the user's viewpoint will be referred to as a left speaker unit. The speaker unit located on the right side surface of the front surface from the user's viewpoint will be referred to as a right speaker unit. A speaker unit arranged on an upper portion of the front surface from the user's viewpoint will be referred to as an upper speaker unit. A speaker unit arranged on a lower portion of the front surface from the user's viewpoint will be referred to as a lower speaker unit.

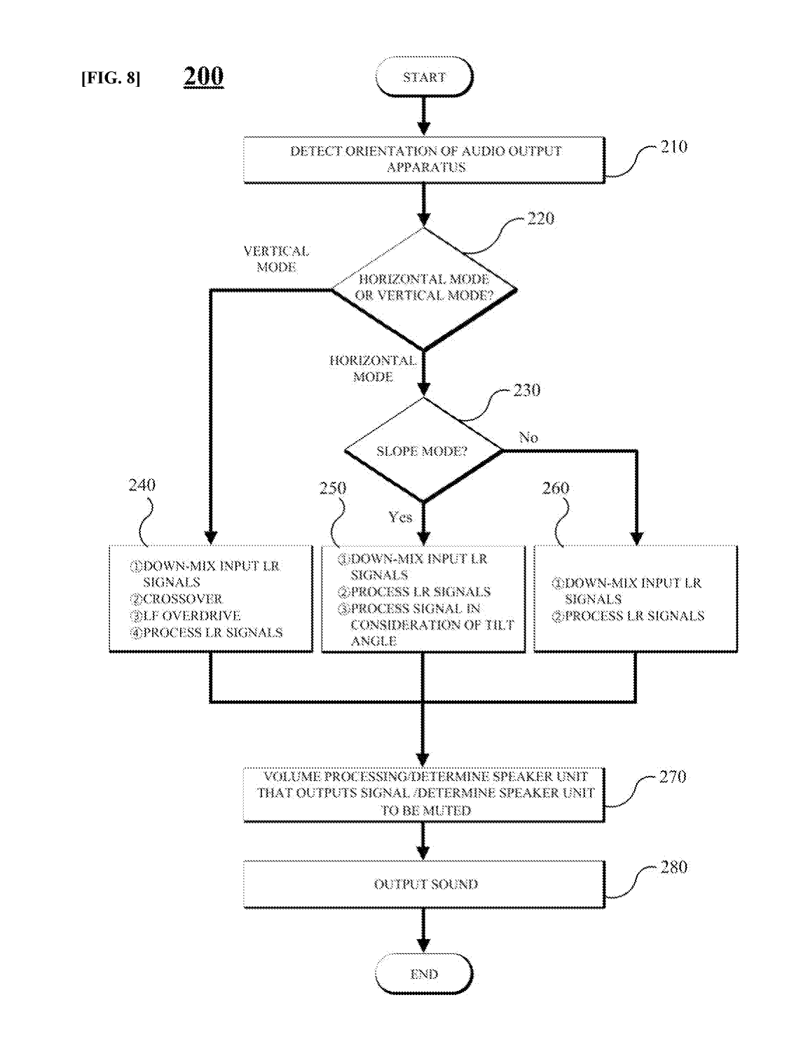

FIG. 8 illustrates an example of a flowchart for a method 200 of controlling sound to be output from speaker units, performed by the audio output apparatus 100.

The audio output apparatus 100 detects the orientation thereof (operation S210). The audio output apparatus 100 processes signals by largely dividing them into three type signals according to the detected orientation. The audio output apparatus 100 determines whether the current orientation thereof is a horizontal mode or a vertical mode (operation S220).

When the current orientation is the vertical mode, the audio output apparatus 100 may perform signal processing to be described below (operation S240). When the current orientation is the vertical mode, \textcircled{1} the audio output apparatus 100 down-mixes input left and right channel (LR) signals. The audio output apparatus 100 may output the down mixed signal to speaker units S1 and S2 arranged on a first side surface thereof in the vertical mode. \textcircled{2} Furthermore, the audio output apparatus 100 may perform crossover to divide the signal obtained by down-mixing the left-channel signal and/or the right-channel signal into a high-frequency signal and a low-frequency signal. The audio output apparatus 100 may output the high-frequency signal to a speaker unit arranged on an upper portion of the first side surface thereof. The audio output apparatus 100 may output the low-frequency signal to a speaker unit arranged on a lower portion of the first side surface. \textcircled{3} Furthermore, the audio output apparatus 100 may process the low-frequency signal LF to be in constant overdrive. The audio output apparatus 100 may output the low-frequency signal processed to be in overdrive to the speaker unit arranged on the lower portion of the first side surface. \textcircled{4} The audio output apparatus 100 may process the left-channel signal and the right-channel signal, and respectively output the left-channel signal and the right-channel signal to a speaker unit arranged on a left side surface of the audio output apparatus 100 from a user's viewpoint and a speaker unit arranged on a right side surface of the audio output apparatus 100 from the user's viewpoint.

When the current orientation is the horizontal mode, the audio output apparatus 100 determines whether the audio output apparatus 100 is in a state (a slope mode) in which the audio output apparatus 100 forms an angle with a floor surface (operation S230).

When the audio output apparatus 100 is in the slope mode, the audio output apparatus 100 may perform signal processing to be described below (operation S250). When the audio output apparatus 100 is in the slope mode, \textcircled{1} the audio output apparatus 100 down-mixes input left and right channel (LR) signals. The audio output apparatus 100 may output the down mixed signal to a speaker unit arranged on an upper side surface of the audio output apparatus 100 extending from the first side surface in the slope mode. \textcircled{2} The audio output apparatus 100 processes the left-channel signal and the right-channel signal. The audio output apparatus 100 outputs the left-channel signal to a speaker unit located at the left of the first side surface from the user's viewpoint. The audio output apparatus 100 outputs the right-channel signal to a speaker unit located at the right of the first side surface from the user's viewpoint. \textcircled{3} Furthermore, the audio output apparatus 100 may differently process a signal to be output from a speaker unit according to an angle formed by the audio output apparatus 100 and an XY plane (the floor surface). The audio output apparatus 100 may process the down mixed signal on the basis of the angle according to a certain method. Thus, an effect such as center enhancement may be given.

When the audio output apparatus 100 is in a general horizontal mode other than the slope mode, the audio output apparatus 100 may perform signal processing to be described below (operation S260). When the audio output apparatus 100 is in the horizontal mode, \textcircled{1} the audio output apparatus 100 down-mixes input left and right channel (LR) signals. The audio output apparatus 100 may output the down mixed signal to the speaker unit arranged on the upper side surface extending from the first side surface. \textcircled{2} The audio output apparatus 100 processes the left-channel signal and the right-channel signal. The audio output apparatus 100 outputs the left-channel signal to the speaker unit arranged at the left of the first side surface from a user's viewpoint. The audio output apparatus 100 outputs the right-channel signal to the speaker unit arranged at the right of the first side surface from the user's viewpoint.

After basic audio signal processing is completed, the audio output apparatus 100 may perform additional processing to be described below (operation S270). The audio output apparatus 100 may process a signal to be output at a certain audio level according to an input volume level. The audio output apparatus 100 may match the processed signal with a speaker unit from which the processed signal is to be output, so that a different signal may be transferred to each speaker unit. Furthermore, the audio output apparatus 100 may mute a speaker unit which is in contact with the floor surface not to output sound in the horizontal mode.

Finally, the audio output apparatus 100 outputs sound via each speaker unit (operation S280).

The above-described apparatus may be implemented as a hardware component, a software component, and/or a combination of a hardware component and a software component. For example, the devices and components of the above-described embodiments may be implemented using one or more general-purpose or special-purpose computers, such as a processor, a controller, an arithmetic logic unit (ALU), a digital signal processor, a microcomputer, a field programmable gate array (FPGA), a programmable logic unit (PLU), a microprocessor, or any other devices capable of executing and responding to an instruction. A processing device may execute an operating system (OS) and one or more software applications running on the OS. In addition, the processing device may access, store, manipulate, process, and generate data in response to execution of the software. For convenience of understanding, the processing device may be described as a single unit, but those skilled in the art will recognize that the processor may include a plurality of processing elements and/or a plurality of types of processing elements. For example, the processing device may include a plurality of processors, or one processor and one controller. Other processing configurations are also possible, such as a parallel processor.

The software may include a computer program, code, instructions, or a combination of one or more of the foregoing, and may configure or independently or collectively instruct the processing device to operate as desired. Software and/or data may be embodied permanently or temporarily on any type of machine, component, physical device, virtual equipment, computer storage media or device, or in a propagated signal wave so as to be interpreted by the processing device or to provide the processing device with instructions or data. The software may be distributed over a networked computer system and stored or executed in a distributed manner. The software and data may be stored on one or more computer readable recording media.

The present embodiment and the accompanying drawings in this specification are only a part of the technical scope included in the above-described technique, and all variations and specific embodiments which can be easily inferred by those skilled in the art within the technical scope included in the specification and drawings of the above-described technique may be understood as being included in the scope of the above-described technique.

What is claimed is:

1. A method of controlling an audio output according to an orientation of an audio output apparatus, performed by the audio output apparatus, the method comprising:
receiving a stereo signal;
detecting the orientation of the audio output apparatus using a sensor;
outputting the stereo signal to a left speaker unit and a right speaker unit on a front surface portion of the audio output apparatus on which two speaker units are arranged in current arrangement of speaker units; and
outputting a signal obtained by down-mixing the stereo signal to at least one of an upper speaker unit and a lower speaker unit in the current arrangement of the speaker units.

2. The method of claim 1, wherein the audio output apparatus determines a speaker unit that outputs the stereo signal and a speaker unit that the down mixed signal, according to whether a lengthwise direction in which the two speaker units arranged on the front surface portion are connected to each other is horizontal or vertical to a floor surface on which the audio output apparatus is located.

3. The method of claim 1, wherein, when a lengthwise direction in which the two speaker units arranged on the front surface portion are connected to each other is horizontal to a floor surface on which the audio output apparatus is located or forms an acute angle which is equal to or less than a reference angle with respect to the floor surface, the audio output apparatus outputs a left-channel signal included in the stereo signal to the left speaker unit located in a left side among the two speaker units and a right-channel signal included in the stereo signal to the right speaker unit which is the other speaker unit.

4. The method of claim 1, wherein, when a lengthwise direction in which the two speaker units arranged on the front surface portion are connected to each other is horizontal to a floor surface on which the audio output apparatus is located or forms an acute angle which is equal to or less than a reference angle with respect to the floor surface, the audio output apparatus outputs the down mixed signal to the upper speaker unit arranged on an upper side surface extending from the front surface portion.

5. The method of claim 1, wherein, when a lengthwise direction in which the two speaker units arranged on the front surface portion are connected to each other is horizontal to a floor surface on which the audio output apparatus is located or forms an acute angle which is equal to or less than a reference angle with respect to the floor surface, the audio output apparatus does not output any signal to the lower speaker unit arranged on a lower side surface extending from the front surface portion.

6. The method of claim 1, wherein, when a lengthwise direction in which the two speaker units arranged on the front surface portion are connected to each other is horizontal to a floor surface on which the audio output apparatus is located or forms an acute angle which is equal to or less than a reference angle with respect to the floor surface and when a lower side surface extending from the front surface portion forms a certain angle with respect to the floor surface on which the audio output apparatus is arranged, the audio output apparatus outputs the down mixed signal to the lower speaker unit arranged on the lower side surface.

7. The method of claim 1, wherein, when a lengthwise direction in which the two speaker units arranged on the front surface portion of the audio output apparatus are connected to each other is a direction vertical to a floor surface on which the audio output apparatus is located or forms an acute angle which is equal to or less than a reference angle with respect to a straight line perpendicular to the floor surface, the audio output apparatus outputs a left-channel signal included in the stereo signal to a left side surface and a right-channel signal included in the stereo signal to a right side surface among side surfaces extending from the front surface portion.

8. The method of claim 1, wherein, when a lengthwise direction in which the two speaker units arranged on the front surface portion are connected to each other is vertical to a floor surface on which the audio output apparatus is located or forms an acute angle which is equal to or less than a reference angle with respect to a straight line perpendicular to the floor surface, the audio output apparatus outputs the down mixed signal to the two speaker units.

9. The method of claim 1, wherein, when a lengthwise direction in which the two speaker units arranged on the front surface portion are connected to each other is vertical to a floor surface on which the audio output apparatus is located or forms an acute angle which is equal to or less than a reference angle with respect to a straight line perpendicular to the floor surface, the audio output apparatus outputs a high-frequency signal included in the down mixed signal to the upper speaker unit among the two speaker units and a low-frequency signal included in the down mixed signal to the lower speaker unit which is the other speaker unit.

10. The method of claim 1, wherein, when a lengthwise direction in which the two speaker units arranged on the front surface portion are connected to each other is vertical to a floor surface on which the audio output apparatus is located or forms an acute angle which is equal to or less than a reference angle with respect to a straight line perpendicular to the floor surface, the audio output apparatus performs crossover on the down mixed signal to divide this signal into a high-frequency signal and a low-frequency signal.

11. An audio output apparatus for controlling an audio output according to an orientation thereof, the audio output apparatus comprising:
a sensor configured to sense the orientation of the audio output apparatus;
a digital-to-analog converter (DAC) configured to convert a digital signal processed by a processor into an analog signal;
speaker units including two speaker units arranged on a first side surface of a housing of the audio output apparatus, one speaker unit arranged on a second side surface extending from the first side surface in one direction, and one speaker unit arranged on a third side surface extending from the first side surface in a direction opposite to the one direction; and
the processor configured to control a stereo signal to be output to the two speaker units arranged on the first side surface according to the orientation, and control a signal obtained by down-mixing the stereo signal to be output to at least one of an upper speaker unit and a lower speaker unit in current arrangement of the speaker units.

12. The audio output apparatus of claim 11, wherein, when a lengthwise direction in which the two speaker units arranged on the first side surface are connected to each other is horizontal to a floor surface on which the audio output apparatus is located or forms an acute angle which is equal to or less than a reference angle with respect to the floor surface, the processor controls the stereo signal among signals output from the DAC to be output from the two speaker units.

13. The audio output apparatus of claim 12, wherein the processor controls a left-channel signal included in the stereo signal to be output to a left speaker unit located in a left side among the two speaker units and a right-channel signal included in the stereo signal to be output to a right speaker unit which is the other speaker unit.

14. The audio output apparatus of claim 11, wherein, when a lengthwise direction in which the two speaker units arranged on the first side surface are connected to each other is horizontal to a floor surface on which the audio output apparatus is located or forms an acute angle which is equal to or less than a reference angle with respect to the floor surface, the processor controls the stereo signal to be down-mixed and the down-mixed signal to be output to the upper speaker unit arranged on an upper side surface between the second side surface and the third side surface.

15. The audio output apparatus of claim 11, wherein, when a lengthwise direction in which the two speaker units arranged on the first side surface are connected to each other is horizontal to a floor surface on which the audio output apparatus is located or forms an acute angle which is equal to or less than a reference angle with respect to the floor surface, the processor controls any signal not to be output to the lower speaker unit arranged on a lower side surface between the second side surface and the third side surface.

16. The audio output apparatus of claim 11, wherein, when a lengthwise direction in which the two speaker units arranged on the first side surface are connected to each other is vertical to a floor surface on which the audio output apparatus is located or forms an acute angle which is equal to or less than a reference angle with respect to a straight line perpendicular to the floor surface, the processor controls a left-channel signal included in the stereo signal to be output to a speaker unit arranged on a side surface located in a left direction between the second side surface and the third side surface and a right-channel signal included in the stereo signal to be output to a speaker unit arranged on a side surface located in a right direction between the second side surface and the third side surface.

17. The audio output apparatus of claim 11, wherein, when a lengthwise direction in which the two speaker units arranged on the first side surface are connected to each other is vertical to a floor surface on which the audio output apparatus is located or forms an acute angle which is equal to or less than a reference angle with respect to a straight line perpendicular to the floor surface, the processor controls the stereo signal to be down-mixed and the down mixed signal to be output to the two speaker units arranged on the first side surface.

18. The audio output apparatus of claim 17, wherein the processor controls a high-frequency signal included in the down mixed signal to be output to the upper speaker unit among the two speaker units and a low-frequency signal included in the down mixed signal to be output to the lower speaker unit which is the other speaker unit.

19. The audio output apparatus of claim 11, further comprising a memory configured to store an instruction instructing the processor to process the digital signal according to the orientation of the audio output apparatus.
